(19) United States
(12) Patent Application Publication
(10) Pub. No.: US 2020/0408552 A1
(43) Pub. Date: Dec. 31, 2020

(54) SYSTEMS AND METHODS FOR DETERMINING DESTINATION OF NAVIGATION

(71) Applicant: BEIJING DIDI INFINITY TECHNOLOGY AND DEVELOPMENT CO., LTD., Beijing (CN)

(72) Inventors: Shuai YUAN, Beijing (CN); Jing WANG, Beijing (CN); Fenglei WANG, Beijing (CN)

(73) Assignee: BEIJING DIDI INFINITY TECHNOLOGY AND DEVELOPMENT CO., LTD., Beijing (CN)

(21) Appl. No.: 17/017,902

(22) Filed: Sep. 11, 2020

Related U.S. Application Data
(63) Continuation of application No. PCT/CN2019/078257, filed on Mar. 15, 2019.

(30) Foreign Application Priority Data
Mar. 15, 2018 (CN) 201810212596.X

(51) Int. Cl. G01C 21/34; G01C 21/00; G01C 21/36; G06F 16/909

(52) U.S. Cl. CPC G01C 21/3484; G01C 21/3407; H04W 4/024; G01C 21/3617; G06F 16/909; G01C 21/3807

(57) ABSTRACT

A method for determining recommended destination of navigations is provided. The method may include obtaining a plurality of orders and mapping each order onto one of at least one grid. The method may further include classifying the at least one grid into one or more clusters and determining a confidence level of each cluster. The method may further include sequencing the one or more clusters based on the confidence level, from a cluster with the highest confidence level to a cluster with the lowest confidence level and obtaining a preset number of target clusters from the sequenced clusters. The method may further include designating a center point of a target grid of the target clusters as a guiding location, determining a confidence level of a road associated with the guiding location, and determining, based on the confidence level of the road associated with the guiding location, whether to designate the guiding location as a destination of navigation.

### CROSS-REFERENCE TO RELATED APPLICATION

This application is a Continuation of International Application No. PCT/CN2019/078257, filed on Mar. 15, 2019, which claims priority to Chinese Patent Application No. 201810212596.X, filed on Mar. 15, 2018, the entire content of each of which is hereby incorporated by reference.

### TECHNICAL FIELD

The present disclosure generally relates to navigation, and in particular, to systems and methods for determining a recommended destination of navigation in an online-to-offline (O2O) service.

### BACKGROUND

With the development of Internet technology, online services, such as online to offline (O2O) services, play a more and more significant role in people's daily lives. For example, a passenger of an online transportation service platform sends a vehicle hailing service request to the transportation service platform; the transportation service platform allocates the service request to a driver that is in communication with the transportation service platform; the driver accepts the service request, picks up the passenger and delivers the passenger to a destination. In some cases, problems arise when the passenger sets a building or a region as the destination but the building or region is inaccessible by vehicles. To deal with such problems, navigation systems or transportation service systems (usually associated with the transportation service platform) often determine a road that is bound to or associated with the building or region as a target road and designate a point on the target road as a destination of navigation. However, the destination set by the navigation system is often inaccurate and the road associated with the destination is usually unsuitable. For example, the “real destination” (e.g., the place that the passenger wants to go to) and the location when the navigation finishes may be far away from each other or on two different roads or regions, making it very difficult for the passenger to reach the real destination. In many cases, the passenger needs to either orally direct the driver to a location near the “real destination” or walk a long distance after being dropped off.

Thus, it is desirable to provide systems and methods for determining a recommended destination of navigation that is close to and/or easy to reach the “real destination”.

### SUMMARY

According to an aspect of the present disclosure, a method for mining guiding drop-off locations is provided. The method may include obtaining a plurality of orders and mapping each order onto one of at least one grid. The method may further include classifying the at least one grid into one or more clusters and determining a confidence level of each cluster. The method may further include sequencing the one or more clusters based on the confidence level, from a cluster with the highest confidence level to a cluster with the lowest confidence level and obtaining a preset number of target clusters from the sequenced clusters. The method may further include designating a center point of a target grid of the target clusters as a guiding location, determining a confidence level of a road associated with the guiding location, and determining, based on the confidence level of the road associated with the guiding location, whether to designate the guiding location as a destination of navigation.

In some embodiments, the classifying the at least one grid into one or more clusters may include determining, based on a count of actual drop-off locations in each grid, a popularity degree of each grid, sequencing the at least one grid based on the popularity degree, and determining, based on the sequence related to the popularity degree, whether a grid is within a preset range from any of the one or more clusters. In response to a determination that the grid is within a preset range from one of the one or more clusters, the grid may be classified to the cluster. In response to a determination that the grid is not within a preset range from any of the one or more clusters, a new cluster may be added to the one or more clusters and the grid may be classified to the new cluster.

In some embodiments, the designating a center point of a target grid of the target clusters as a guiding location may include determining a grid that is in the center of the target cluster as a guiding grid and determining a center point of the guiding grid as the guiding location. Alternatively, the designating a center point of a target grid of the target clusters as a guiding location may include determining a count of drop-off locations in each of the at least one grid, selecting a target grid from the at least one grid based on the count of drop-off locations in each of the at least one grid, and determining a center point of the target grid as the guiding location.

In some embodiments, the determining a confidence level of each cluster may include determining, for each cluster, a ratio of a count of actual drop-off locations in the cluster and a count of destinations in the cluster as the confidence level of the cluster.

In some embodiments, the determining a confidence level of a road associated with the guiding location may include determining a total count of roads associated with grids in the target cluster, determining a count of the road associated with the guiding location in the target cluster, and determining a ratio of the total count of roads associated with grids in the target cluster and the count of the road associated with the guiding location in the target cluster as the confidence level of the road associated with the guiding location.

In some embodiments, the count of destinations in the orders for each order may be greater than a preset threshold and the initiation time of each order may be within a preset time range.

According to another aspect of the present disclosure, a device for mining guiding drop-off locations is provided. The device may include a mapping unit, a classification unit, a first calculation unit, an acquisition unit, a processor unit, a second calculation unit, and a determination unit. The mapping unit may be configured to obtain a plurality of orders and map each order onto one of at least one grid. The classification unit may be configured to classify the at least one grid into one or more clusters. The first calculation unit may be configured to determine a confidence level of each cluster. The acquisition unit may be configured to sequence the one or more clusters based on the confidence level, from a cluster with the highest confidence level to a cluster with the lowest confidence level and obtain a preset number of target clusters from the sequenced clusters. The processor unit may be configured to designate a center point of a target grid of the target clusters as a guiding location. The second calculation unit may be configured to determine a confidence level of a road associated with the guiding location. The determination unit may be configured to determine, based on the confidence level of the road associated with the guiding location, whether to designate the guiding location as a destination of navigation.

According to another aspect of the present disclosure, a server is provided. The server may include a device for mining guiding drop-off locations.

According to another aspect of the present disclosure, a computer device is provided. The computer device may include at least one computer-readable storage medium including a set of instructions and at least one processor in communication with the at least one computer-readable storage medium. When executing the set of instructions, the at least one processor may be directed to perform a method for mining guiding drop-off locations.

According to another aspect of the present disclosure, a non-transitory computer-readable storage medium embodying a computer program product is provided. The computer program product may include instructions and be configured to cause a computing device to perform a method for mining guiding drop-off locations.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary service system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4 is a schematic diagram illustrating an exemplary navigation scenario using a prior art method;

FIG. 5 is a schematic diagram illustrating an exemplary navigation scenario using a prior art method;

FIG. 6 is a block diagram illustrating exemplary processing device according to some embodiments of the present disclosure;

FIG. 7 is a flowchart illustrating an exemplary process for determining a destination of navigation according to some embodiments of the present disclosure;

FIG. 8A and FIG. 8B are flowcharts illustrating exemplary processes for determining a guiding location according to some embodiments of the present disclosure;

FIG. 9 is a flowchart illustrating an exemplary process for classifying grid into clusters according to some embodiments of the present disclosure; and

FIG. 10 is schematic diagram illustrating the determination of a destination of navigation according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is to describe particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to distributing a request for a transportation service, it should also be understood that the present disclosure is not intended to be limiting. The system or method of the present disclosure may be applied to any other kind of services. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may be implemented on a user device and include a webpage, a plug-in of a browser, a client terminal, a custom system, an internal analysis system, an artificial intelligence robot, or the like, or any combination thereof.

The term “passenger,” “requester,” “service requester,” and “customer” in the present disclosure are used interchangeably to refer to an individual, an entity, or a tool that may request or order a service. Also, the term “driver,” “provider,” and “service provider” in the present disclosure are used interchangeably to refer to an individual, an entity, or a tool that may provide a service or facilitate the providing of the service.

The term “service request,” “request for a service,” “requests,” and “order” in the present disclosure are used interchangeably to refer to a request that may be initiated by a passenger, a service requester, a customer, a driver, a provider, a service provider, or the like, or any combination thereof. The service request may be accepted by any one of a passenger, a service requester, a customer, a driver, a provider, or a service provider. The service request may be chargeable or free.

The term “service provider terminal,” “provider terminal,” and “driver terminal” in the present disclosure are used interchangeably to refer to a mobile terminal that is used by a service provider to provide a service or facilitate the providing of the service. The term “service requester terminal,” “requester terminal,” and “passenger terminal” in the present disclosure are used interchangeably to refer to a mobile terminal that is used by a service requester to request or order a service.

The term “destination” and “original destination” in the present disclosure are used interchangeably to refer to a location inputted by a service requester (or a service provider) when the service request is initiated. The term “drop-off location” and “actual drop-off location” in the present disclosure are used interchangeably to refer to a location where a service requester is dropped off by a service provider.

In some embodiments, the present method may be related to the determination of a recommended destination of navigation in a service request (as a replacement of an original destination inputted by the service requester). However, it shall not be limiting. The determined recommended destination may be used as a destination in any kind of navigation service. For example, when a driver accepts a service request, a navigation system may direct the driver from his or her current location to the current location of a passenger. The present method may be used to determine a recommended destination of navigation from the driver's current location to the passenger's current location (in this case, a recommended pick-up location).

In some embodiments, the present method may be used to determine only a destination of navigation which doesn't include any selection of navigation routes nor target roads. Hence the processor or platform used for generating the destination of navigation may be same as or different from the processor or platform used for navigation. For example, a navigation processor or platform may independently generate a navigation route based on the destination of navigation generated by another processor or platform.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to systems and methods for determining a recommended destination of navigation. In some embodiments, the recommended destination of navigation may be generated based on historical service orders. For example, the historical service orders may each include an original destination, and an actual drop-off location. The original destination may be a location inputted by a service requester when sending the corresponding service request. The actual drop-off location may be a location where the service requester is actually dropped off. Merely by way of example, when the service requester is delivered to the original destination, the service requester may notice that the original destination (or a location when a corresponding navigation to the original destination finishes) is slightly different from the place where he or she wants to go (e.g., on the opposite side of a road, at a wrong entrance, a bit distant from the place where he or she wants to go). Accordingly, the service requester may ask the service provider to drive him or her to and drop off him or her at a location that is more convenient for him or her to reach the place where he or she wants to go. Such location may be referred to as the actual drop-off location.

In some embodiments, a plurality of historical service orders may be obtained. The historical service orders, as mentioned above, may each include an original destination inputted by a service requester and an actual drop-off location. The drop-off locations may be mapped onto grids of a map. The grids (together with the drop-off locations thereof) may be classified into one or more clusters based on the number of drop-off locations in the grids. At least one target cluster may be selected from the one or more clusters according to the confidence level of the one or more clusters. The confidence level of each cluster may be determined based on the count of original destinations and the count of drop-off locations in the clusters. For each of the at least one target cluster, a guiding location is determined. The guiding location may be a center point of a center grid in the target cluster or a center point of a popular grid (e.g., a grid that includes many drop-off locations). A road that is bound to or associated with the guiding location may be determined and the confidence level of the road may be calculated. If the confidence level of the road bound to or associated with the guiding location is greater than or equal to a road threshold, the guiding location may be designated as a recommended destination of navigation.

The recommended destination of navigation may be a location where the service requesters are usually dropped off and may be associated with a road that can be easily accessed (e.g., without traffic restrictions, and/or without traffic jams). When a service requester sends a service request to a service providing platform with a destination that is close to or in the same region as the recommended destination of navigation, the service providing platform may replace the original destination by the recommended destination of navigation. The replacement of the original destination may or may not require a permission of the service requester. For example, the service providing platform or the associated navigation application may send a message to the service requester to ask him or her whether he or she wants to change the original destination to the recommended destination of navigation.

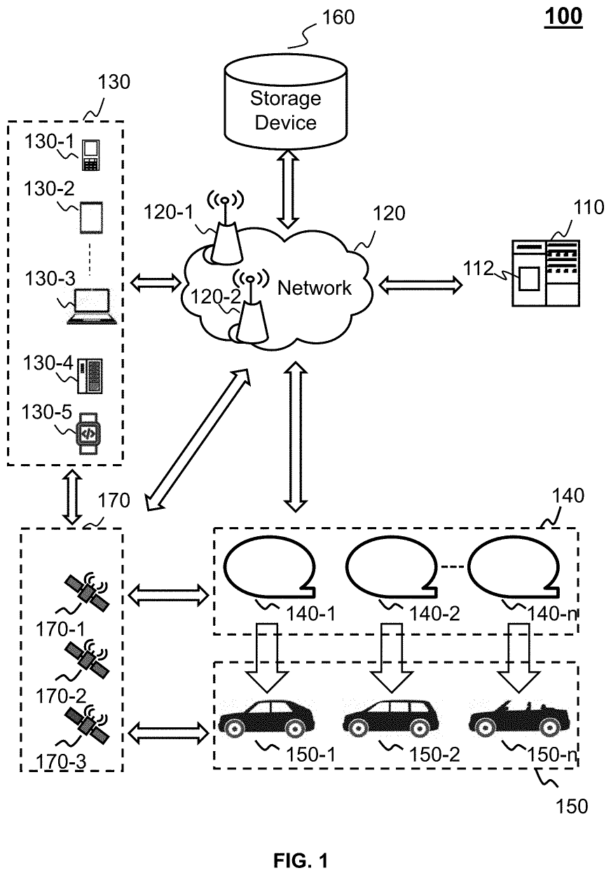

FIG. 1 is a schematic diagram illustrating an exemplary service system according to some embodiments of the present disclosure. Service system 100 may be configured to provide one or more services. The service(s) may include any product, such as but not limited to food, medicine, commodity, chemical product, electrical appliance, clothing, car, housing, luxury, a servicing product, a financial product, a knowledge product, and an Internet product. In some embodiments, the service(s) may include an online-to-offline (O2O) service. Exemplary O2O services may include a transportation service (e.g., a taxi-hailing service, a chauffeur service, an express car service, a carpool service, a bus service, a driver hire service, and a shuttle service), a meal booking service, a delivery service, a shopping service, or the like, or any combination thereof. For example, the service system 100 may be an online transportation service platform for transportation services, an online delivery service platform for meal delivery services, an online shopping service platform for shopping services, etc.

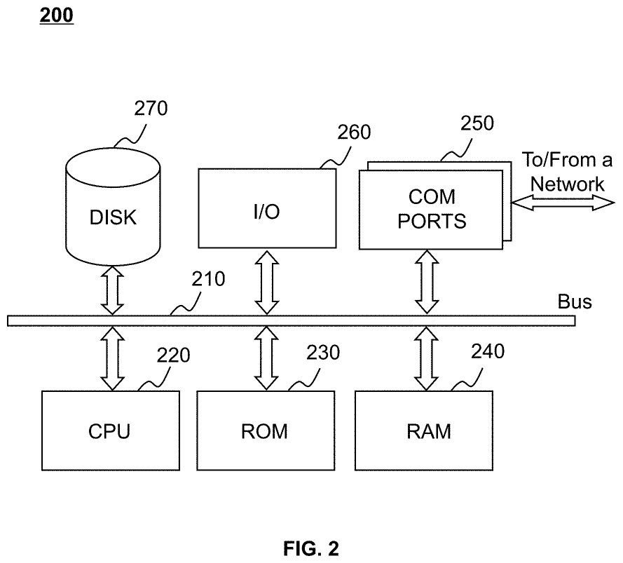

For illustration purposes, the following description regarding the service system 100 is provided with reference to an online transportation service system. As illustrated in FIG. 1, the service system 100 may include a server 110, a network 120, a requester terminal 130, a provider terminal 140, a vehicle 150, a storage device 160, and a navigation system 170. In some embodiments, the server 110 may be a single server or a server group. The server group may be centralized or distributed (e.g., the server 110 may be a distributed system). In some embodiments, the server 110 may be local or remote. For example, the server 110 may access information and/or data stored in the requester terminal 130, the provider terminal 140, and/or the storage device 160 via the network 120. As another example, the server 110 may be directly connected to the requester terminal 130, the provider terminal 140, and/or the storage device 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing device 112. According to some embodiments of the present disclosure, the processing device 112 may process information and/or data related to historical orders to perform one or more functions described in the present disclosure. For example, the processing device 112 may process historical operation data of the service system 100 (e.g., the server 110) associated with the historical orders to determine one or more actual drop-off locations and one or more original destinations. As another example, the processing device 112 may determine a recommended destination of navigation based on the one or more actual drop-off locations and the one or more original destinations. As a further example, when the processing device 112 receives a service request that includes a destination close to the recommended destination of navigation, the processing device 112 may generate an instruction to replace the destination by the recommended destination of navigation, either with or without the permission of the service requester.

In some embodiments, the processing device 112 may include one or more processing devices (e.g., single-core processing device(s) or multi-core processor(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the service system 100 (e.g., the server 110, the requester terminal 130, the provider terminal 140, the vehicle 150, the storage device 160, or the navigation system 170) may transmit information and/or data to other component(s) of the service system 100 via the network 120. For example, the server 110 may obtain operation data or historical operation data of the service system 100 from a storage device (e.g., the storage device 160) via the network 120. As another example, the server 110 may obtain operation data or historical operation data from a storage device of the requester terminal 130 or a storage device of the provider terminal 140 via the network 120. The operation data or the historical operation data may be associated with orders or historical orders. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, through which one or more components of the service system 100 may be connected to the network 120 to exchange data and/or information.

In some embodiments, a service requester may be an owner of the requester terminal 130. In some embodiments, the owner of the requester terminal 130 may be someone other than the service requester. For example, an owner A of the requester terminal 130 may use the requester terminal 130 to transmit a service request for a service requester B or receive a service confirmation and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a service provider D, and/or information or instructions from the server 110. In some embodiments, “requester,” “service requester” and “requester terminal” may be used interchangeably, and “provider,” “service provider,” and “service provider terminal” may be used interchangeably. In some embodiments, the service provider terminal may be associated with one or more service providers (e.g., a night-shift service provider, or a day-shift service provider).

In some embodiments, the requester terminal 130 may include a mobile device 130-1, a tablet computer 130-2, a laptop computer 130-3, a built-in device in a vehicle 130-4, a wearable device 130-5, or the like, or any combination thereof. In some embodiments, the mobile device 130-1 may include a smart home device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include Google™ Glasses, an Oculus Rift™, a HoloLens™, a Gear VR™, etc. In some embodiments, the built-in device in the vehicle 130-4 may include an onboard computer, an onboard television, etc. In some embodiments, the wearable device 130-5 may include a smart bracelet, a smart footgear, smart glasses, a smart helmet, a smart watch, smart clothing, a smart backpack, a smart accessory, or the like, or any combination thereof. In some embodiments, the requester terminal 130 may be a device with positioning technology for locating the position of the service requester and/or the requester terminal 130.

The provider terminal 140 may include a plurality of provider terminals 140-1, 140-2, . . . , 140-n. In some embodiments, the provider terminal 140 may be similar to, or the same device as the requester terminal 130. In some embodiments, the provider terminal 140 may be customized to be able to implement the service system 100. In some embodiments, the provider terminal 140 may be a device with positioning technology for locating the service provider, the provider terminal 140, and/or the vehicle 150 associated with the provider terminal 140. In some embodiments, the requester terminal 130 and/or the provider terminal 140 may communicate with another positioning device to determine the position of the service requester, the requester terminal 130, the service provider, and/or the provider terminal 140. In some embodiments, the requester terminal 130 and/or the provider terminal 140 may periodically transmit the positioning information to the server 110. In some embodiments, the provider terminal 140 may also periodically transmit the availability status to the server 110. The availability status may indicate whether the vehicle 150 associated with the provider terminal 140 is available to carry a service requester. For example, the requester terminal 130 and/or the provider terminal 140 may transmit the positioning information and the availability status to the server 110 every thirty minutes. As another example, the requester terminal 130 and/or the provider terminal 140 may transmit the positioning information and the availability status to the server 110 each time the user logs into the mobile application associated with the service system 100.

In some embodiments, the provider terminal 140 may correspond to one or more vehicles 150. The vehicles 150 may carry the service requester and travel to a destination requested by the service requester. The vehicles 150 may include a plurality of vehicles 150-1, 150-2, . . . , 150-n. One vehicle may correspond to one type of services (e.g., a taxi-hailing service, a chauffeur service, an express car service, a carpool service, a bus service, a driver hire service, or a shuttle service).

The storage device 160 may store data and/or instructions. In some embodiments, the storage device 160 may store data obtained from the requester terminal 130 and/or the provider terminal 140. In some embodiments, the storage device 160 may store data and/or instructions that the server 110 may execute or use to perform exemplary methods described in the present disclosure. For example, the storage device 160 may store operation data and/or historical operation data of the service system 100. The operation data or the historical operation data may be associated with orders or historical orders. In some embodiments, the storage device 160 may include a mass storage device, a removable storage device, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 160 may be connected to the network 120 to communicate with one or more components of the service system 100 (e.g., the server 110, the requester terminal 130, or the provider terminal 140). One or more components of the service system 100 may access the data or instructions stored in the storage device 160 via the network 120. In some embodiments, the storage device 160 may be directly connected to or communicate with one or more components of the service system 100 (e.g., the server 110, the requester terminal 130, the provider terminal 140). In some embodiments, the storage device 160 may be part of the server 110.

The navigation system 170 may determine information associated with an object, for example, one or more of the requester terminal 130, the provider terminal 140, the vehicle 150, etc. In some embodiments, the navigation system 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The navigation system 170 may include one or more satellites, for example, a satellite 170-1, a satellite 170-2, and a satellite 170-3. The satellites 170-1 through 170-3 may determine the information mentioned above independently or jointly. The navigation system 170 may transmit the information mentioned above to the network 120, the requester terminal 130, the provider terminal 140, or the vehicle 150 via wireless connections. In some embodiments, the navigation system 170 may be configured to provide a navigation service or a map service to the requester terminal 130, the provider 140 and/or the vehicle 150. For example, the navigation system 170 or a storage device thereof may store a digital map. The navigation system 170 may determine location(s) or geographical coordinate(s) of the requester terminal 130, the provider terminal 140, and/or the vehicle 150 via the satellites 170-1, 170-2, and/or 170-3. The navigation system 170 may label the requester terminal 130, the provider terminal 140, and/or the vehicle 150 onto the digital map based on their corresponding location(s) or geographical coordinate(s). In some embodiments, the digital map may be transmitted to the processing device 110 and further processed. The digital map may also be transmitted to the requester terminal 130, the provider terminal 140, and/or the vehicle 150. The digital map may be displayed on screens of the requester terminal 130, the provider terminal 140, and/or the vehicle 150 via user interfaces thereof. The digital map may be updated every few seconds or at any time when the navigation system 170 detects a movement of the requester terminal 130, the provider terminal 140, and/or the vehicle 150. In some embodiments, the navigation system 170 and/or the processing device 112 may generate a route from a pick-up location (e.g., a location where a service requester is picked up) to an original destination. Alternatively, or additionally, the processing device 112 may generate a route from the pick-up location to a recommended destination of navigation.

In some embodiments, one or more components of the service system 100 (e.g., the server 110, the requester terminal 130, the provider terminal 140) may have permissions to access the storage device 160. In some embodiments, one or more components of the service system 100 may read and/or modify information related to the service requester, the service provider, and/or the public when one or more conditions are met. For example, the server 110 may read and/or modify one or more service requesters' information after a service is completed. As another example, the server 110 may read and/or modify one or more service providers' information after a service is completed.

In some embodiments, information exchanging of one or more components of the service system 100 may be initiated by way of requesting a service. The object of the service request may be any product. In some embodiments, the product may include food, medicine, commodity, chemical product, electrical appliance, clothing, car, housing, luxury, or the like, or any combination thereof. In some other embodiments, the product may include a servicing product, a financial product, a knowledge product, an Internet product, or the like, or any combination thereof. The Internet product may include an individual host product, a web product, a mobile Internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistant (PDA), a smart watch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application related to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element (or component) of the service system 100 performs, the element may perform through electrical signals and/or electromagnetic signals. For example, when a requester terminal 130 transmits out a service request to the server 110, a processor of the requester terminal 130 may generate an electrical signal encoding the service request. The processor of the requester terminal 130 may then transmit the electrical signal to an output port. If the requester terminal 130 communicates with the server 110 via a wired network, the output port may be physically connected to a cable, which further may transmit the electrical signal to an input port of the server 110. If the requester terminal 130 communicates with the server 110 via a wireless network, the output port of the requester terminal 130 may be one or more antennas, which convert the electrical signal to electromagnetic signal. Similarly, a provider terminal 140 may receive an instruction and/or service request from the server 110 via electrical signal or electromagnet signals. Within an electronic device, such as the requester terminal 130, the provider terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and/or software components of a computing device according to some embodiments of the present disclosure.

In some embodiments, the computing device 200 may be a special purpose computer in some embodiments. The computing device 200 may be used to implement any component of the service system 100 as described herein. In some embodiments, the server 110, the requester terminal 130, and/or the provider terminal 140 may be implemented on the computing device 200. For example, the processing device 112 may be implemented on the computing device 200 and configured to perform functions of the processing device 112 disclosed in this disclosure. In FIGS. 1-2, only one such computer device is shown purely for convenience purposes. One of ordinary skill in the art would understood at the time of filing of this application that the computer functions relating to the service system 100 as described herein may be implemented in a distributed fashion on a number of similar platforms, to distribute the processing load.

The computing device 200 may include COM ports 250 that may connect with a network that may implement data communications. The computing device 200 may also include a processor 220, in the form of one or more processors (e.g., logic circuits), for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage (e.g., a hard disk 270, a read-only memory (ROM) 230, a random-access memory (RAM) 240) for storing various data files applicable to computer processing and/or communication and/or program instructions executed possibly by the processor 220. The computing device 200 may also include an I/O device 260 that may support the input and output of data flows between computing device 200 and other components. Moreover, the computing device 200 may receive programs and data via the communication network.

Merely for illustration, only one processor is described in FIG. 2. Multiple processors are also contemplated, thus operations and/or method steps performed by one processor as described in the present disclosure may also be jointly or separately performed by the multiple processors. For example, if in the present disclosure the processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

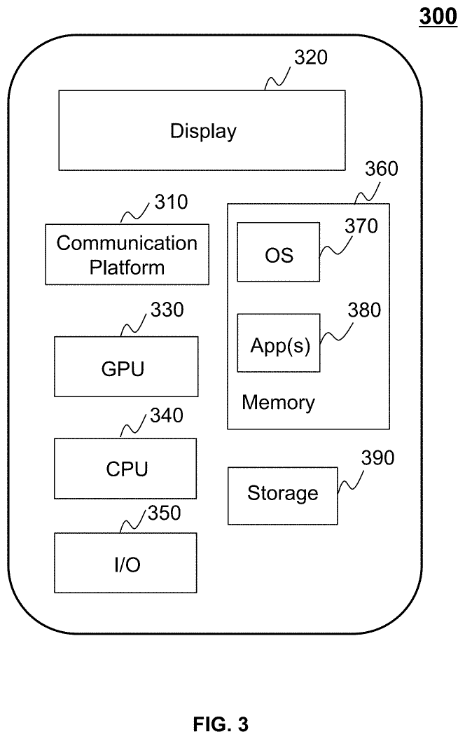

FIG. 3 is a schematic diagram illustrating exemplary hardware and/or software components of a mobile device according to some embodiments of the present disclosure. In some embodiments, the requester terminal 130 and/or the provider terminal 140 may be implemented on the mobile device 300. As illustrated in FIG. 3, the mobile device 300 may include a communication platform 310, a display 320, a graphics processing unit (GPU) 330, a central processing unit (CPU) 340, an I/O 350, a memory 360, a mobile operating system (OS) 370, application (s) 380, and a storage 390. In some embodiments, any other suitable component, including but not limited to a system bus or a controller (not shown), may also be included in the mobile device 300.

In some embodiments, the mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to O2O services or other information from the service system 100. User interactions with the information stream may be achieved via the I/O 350 and provided to the storage device 160, the server 110 and/or other components of the service system 100.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a system if appropriately programmed.

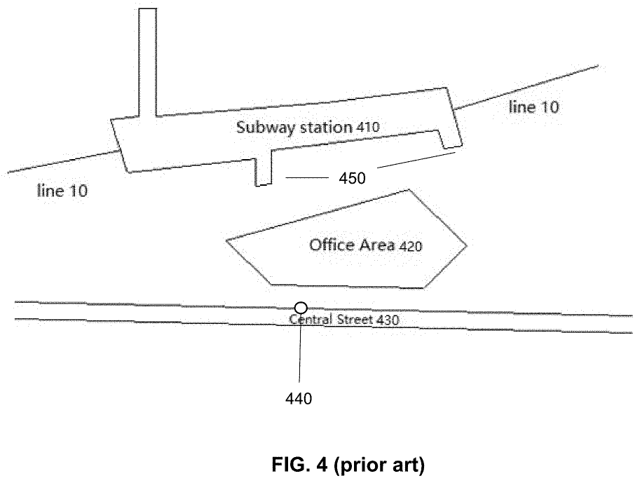

FIG. 4 is a schematic diagram illustrating an exemplary navigation scenario using a prior art method. As shown in FIG. 4, an office area 420 is between a subway station 410 and a central street 430. The subway station 410 may include two entrances 450. A service requester may send a service request to a service provider from his or her current location to a subway station 410 (e.g., setting the subway station 410 as his or her destination). Conventionally, a prior art navigation system or transportation service system may determine a road 430 that is bound to or associated with the subway station 410 as a target road and designate a location on the target road 430 (e.g., location 440 which corresponds to the geometric center of the subway station 410) as a destination of navigation. However, as the office area 420 is between the subway station 410 and the central street 430, the service requester may have to walk a long distance to either of the entrances 450 when the navigation to the location 440 finishes. Hence the location 440 determined by the prior art method may not be a suitable drop-off location.

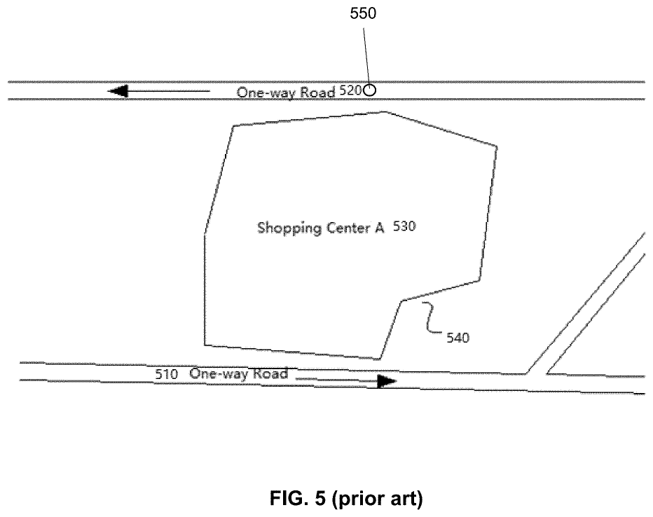

FIG. 5 is a schematic diagram illustrating an exemplary navigation scenario using a prior art method. As shown in FIG. 5, a shopping center A may include an entrance 540. The road 510 and the road 520 may be one-way roads. A service requester may send a service request to a service provider from his or her current location to the shopping center A 530 (e.g., setting the shopping center A 530 as his or her destination). Similar to the conventional method mentioned in descriptions of FIG. 4, a prior art navigation system or transportation service system may determine a road 520 that is bound to or associated with the shopping center A 530 as a target road and designate a location on the target road 520 (e.g., location 550 which corresponds to the geometric center of the shopping center A 530) as a destination of navigation. However, as the entrance 540 is on the other side of the shopping center A 530, the service requester may have to walk a long distance to the entrance 540. In addition, as the road 520 is a one-way road, it may not be possible for the service provider to make a turn and drive the service requester to the entrance 540. In this case, the conventional method navigates t the service requester to an even more unpleasant location than FIG. 4.

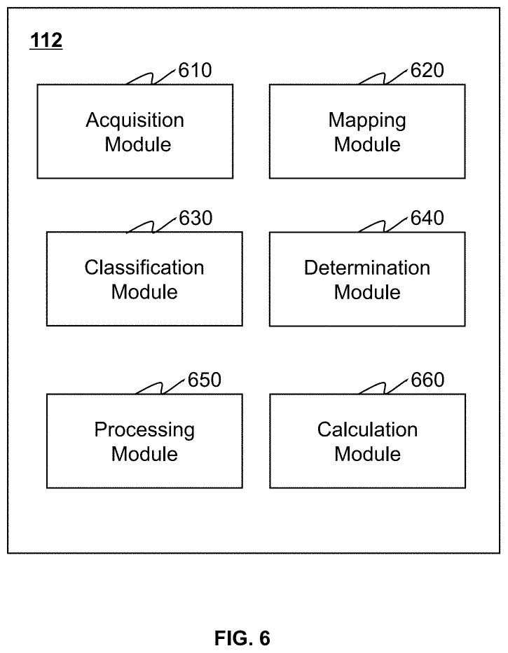

FIG. 6 is a block diagram illustrating exemplary processing device according to some embodiments of the present disclosure. As shown in FIG. 6, the processing device 112 may include an acquisition module 610, a mapping module 620, a classification module 630, a determination module 640, a processing module 650 and a calculation module 660.

The acquisition module (also referred to as an acquisition unit) 610 may be configured to obtain data or information. For example, the data or information may be related to historical orders. In some embodiments, the acquisition module 610 may obtain a plurality of historical orders from a server (e.g., the server 110) or a user terminal (e.g., the requester terminal 130, the provider terminal 140, a vehicle-mounted terminal on the vehicle 150). In some embodiments, the acquisition module 610 may obtain all the historical service orders stored in the server or the user terminal. Alternatively, only some of the historical service orders stored in the server or the user terminal may be obtained. For example, the acquisition module 610 may only obtain historical service orders that are initiated (or completed) in a particular region. As another example, the acquisition module 610 may only obtain historical service orders that are initiated or completed within a preset time range. As a further example, the acquisition module 610 may obtain historical service orders that are associated with a particular user or user group (e.g., historical service orders with male service requesters, historical service orders with female service providers, historical service orders with young (e.g., 18-24 years old) service providers). Merely by way of example, the acquisition module 610 may obtain historical service orders that are initiated (or completed) within 3 months. In some embodiments, the acquisition module 610 may determine a plurality of drop-off locations and/or a plurality of original destinations based on the plurality of historical service orders.

The mapping module (also referred to as a mapping unit) 620 may be configured to map the plurality of drop-off locations onto at least one grid (the at least one grid may collectively refer to a grid set) of a map. In some embodiments, the map may refer to a digital map that may be visualized or displayed on a user terminal (e.g., the requester terminal 130, the provider terminal 140, a vehicle-mounted terminal on the vehicle 150) via a user interface. Alternatively, or additionally, the map may refer to a virtual map (e.g., code) stored in a storage device (e.g., the storage device 160, the ROM 230, the RAM 240, the storage 390). In some embodiments, the at least one grid may be at least one square or rectangle on the map that are segmented according to its geographical coordinates (e.g., latitudes and longitudes). In some embodiments, the “mapping” of the drop-off locations onto the at least one grid of the map may refer to a process of associating the drop-off locations with the at least one grid of the map. For example, the “mapping” may refer to marking the drop-off locations on the at least one grid of a digital map displayed on the user terminal. As another example, the “mapping” may refer to associating the code of the at least one grid with the code of the drop-off locations (e.g., adding a tag of a particular grid to the code of a particular drop-off location).

The classification module (also referred to as a classification unit, or a classification sub-unit) 630 may be configured to classify the at least one grid into the one or more clusters. In some embodiments, the clusters may be marked on the digital map as boundary lines. For example, if two grids are classified into a same cluster, a boundary line may be drawn along the boundaries of the two grids as the cluster. If a third grid is further classified into the cluster, the boundary line of the cluster may be broadened to include the third grid. The classification module 630 may include a determination sub-unit configured to determine the count of drop-off locations (or popularity) in each grid before the classification.

The determination module (also referred to as a determination unit) 640 may be configured to make determinations. For example, the determination module 640 may determine whether the selected grid is within a preset range from any of the existing cluster. In some embodiments, the “within a preset range” may refer to that the grid is either within the boundary of the cluster or less than a preset range from the boundary of the cluster. The preset range may be any value, including but not limited to 10 meters, 20 meters, 30 meters, 50 meters, 100 meters. In some embodiments, the determination module 640 may further determine whether a guiding location satisfies a preset condition. In some embodiments, the preset condition may be used as a determination that whether the guiding location is a suitable destination of navigation.

The processing module (also referred to as a processor unit) 650 may be configured to process information or data generated by or received from the present service system 100 or components thereof. The processing module 650 may select at least one target cluster from the one or more clusters according to the confidence level of each of the one or more clusters. For example, the processing module 650 may determine a sequence of the one or more clusters according to the confidence level of the one or more clusters (e.g., from the cluster with the highest confidence level to the cluster with the lowest confidence level). The processing module 650 may determine a number of target clusters. The number of target clusters may be inputted by the user via a user terminal (e.g., the requester terminal 130, the provider terminal 140, a vehicle-mounted terminal on the vehicle 150) or determined by the processing module 650 or acquisition module 610. The number of target clusters may be any value, including but not limited to, 1, 2, 5, 10, 20, 50, etc. The processing module 650 may determine a location in the at least one target cluster as a guiding location. In some embodiments, the guiding location may be a center point of a grid in the target cluster. For example, the center point of a center grid in the target cluster may be determined as the guiding location.

The calculation module 660 may be configured to calculate the confidence level of a cluster. In some embodiments, the confidence level of the cluster may be determined based on the count of drop-off locations in the cluster and the count of corresponding original destinations in the cluster. The calculation module 660 may also determine a confidence level of a guiding road associated with a guiding location. In some embodiments, the calculation module 660 may include a first calculation unit configured to determine the confidence level of the cluster and a second calculation unit configured to determine the confidence level of the guiding road associated with the guiding location.

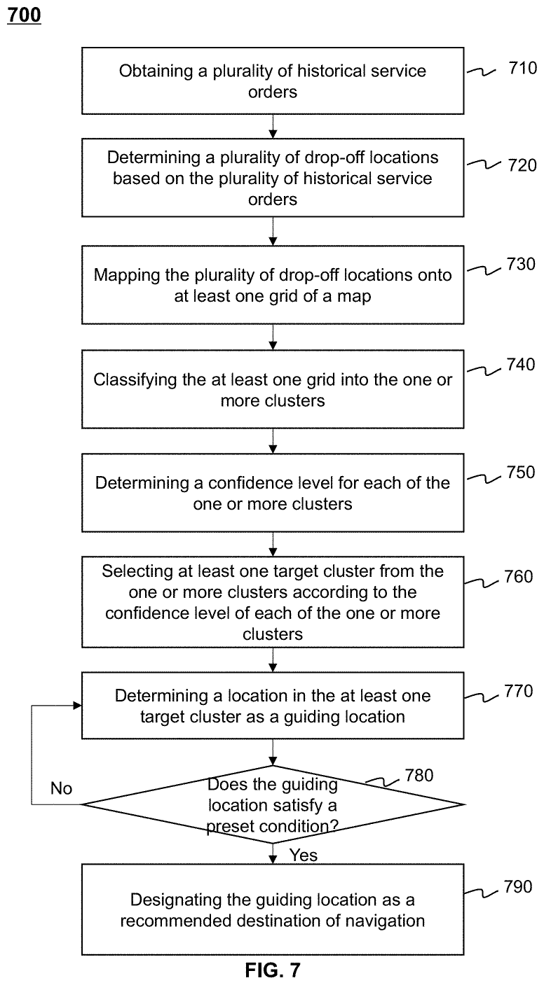

FIG. 7 is a flowchart illustrating an exemplary process for determining a destination of navigation according to some embodiments of the present disclosure. In some embodiments, one or more operations of process 700 may be executed by the service system 100. For example, the process 700 may be implemented as a set of instructions (e.g., an application) stored in a storage device (e.g., the storage device 160, the ROM 230, the RAM 240, the storage 390) and invoked and/or executed by a processing device (e.g., the processing device 112, the processor 220 of the computing device 200, the CPU 340 of the mobile device 300, and/or the modules illustrated in FIG. 6). In some embodiments, the instructions may be transmitted in the form of electronic current or electrical signals. The operations of the illustrated process present below are intended to be illustrative. In some embodiments, the process 700 may be accomplished with one or more additional operations not described and/or without one or more of the operations herein discussed. Additionally, the order in which the operations of the process as illustrated in FIG. 7 and described below is not intended to be limiting.

In 710, the processing device 112 (e.g., the acquisition module 610) may obtain a plurality of historical service orders. In some embodiments, the plurality of historical service orders may be obtained from a server (e.g., the server 110) or a user terminal (e.g., the requester terminal 130, the provider terminal 140, a vehicle-mounted terminal on the vehicle 150). In some embodiments, the processing device 112 may obtain all the historical service orders stored in the server or the user terminal. Alternatively, only some of the historical service orders stored in the server or the user terminal may be obtained. For example, the processing device 112 may only obtain historical service orders that are initiated (or completed) in a particular region. As another example, the processing device 112 may only obtain historical service orders that are initiated or completed within a preset time range. As a further example, the processing device 112 may obtain historical service orders that are associated with a particular user or user group (e.g., historical service orders with male service requesters, historical service orders with female service providers, historical service orders with young (e.g., 18-24 years old) service providers). Merely by way of example, the processing device 112 may obtain historical service orders that are initiated (or completed) within 3 months.

In 720, the processing device 112 (e.g., the acquisition module 610) may determine a plurality of drop-off locations and/or a plurality of original destinations based on the plurality of historical service orders. For example, the historical service orders may each include an original destination, and an actual drop-off location. The original destination may be a location inputted by a service requester when sending the corresponding service request. The actual drop-off location may be a location where the service requester is actually dropped off. Merely by way of example, when the service requester is delivered to the original destination, the service requester may notice that the original destination (or a location when a corresponding navigation to the original destination finishes) is slightly different from the place where he or she wants to go (e.g., on the opposite side of a road, at a wrong entrance, a bit distant from the place where he or she wants to go). Accordingly, the service requester may ask the service provider to drive him or her to and drop him or her off at a location that is more convenient for him or her to reach the place where he or she wants to go. Such location may be referred to as the actual drop-off location.

In some embodiments, different service orders may include same or different drop-off locations. For example, among 10 different service orders in a particular region, 3 service orders correspond to a drop-off location A, 2 service orders correspond to a drop-off location B, and the remaining 5 service orders correspond to drop-off locations C, D, E, F, and G, respectively. In some embodiments, all the drop-off locations may be retained. Alternatively, only some of the drop-off locations may be retained. For example, the count of the drop-off locations in the 10 service orders may be compared with a threshold. If the count of a drop-off locations is greater than or equal to the threshold, the drop-off location may be retained; otherwise, it may be deleted from the 10 service orders. Merely by way of example, the threshold may be 2. In this case, only the drop-off location A and the drop-off location B may be retained. It should be noted that the value of the threshold shall not be limiting. Instead, it can be any number, including but not limited to 1, 2, 5, 10, 20, etc.

In 730, the processing device 112 (e.g., the mapping module 620) may map the plurality of drop-off locations onto at least one grid (the at least one grid may collectively form a grid set) of a map. In some embodiments, the map may refer to a digital map that may be visualized or displayed on a user terminal (e.g., the requester terminal 130, the provider terminal 140, a vehicle-mounted terminal on the vehicle 150) via a user interface. Alternatively, or additionally, the map may refer to a virtual map (e.g., code) stored in a storage device (e.g., the storage device 160, the ROM 230, the RAM 240, the storage 390). Each of the at least one grid may correspond to a non-overlapping region on the map with a particular size and shape. The size and the shape of the at least one grid may be the same as or different from each other. In some embodiments, the at least one grid may be squares or rectangles of the same size and shape. However, the shape of the grid shall not be limited to squares or rectangles. For example, the shape of the grid may be a hexagon, an octagon, a parallelogram, a trapezium, an irregular shape, etc.

In some embodiments, the “mapping” of the drop-off locations onto the at least one grid of the map may refer to a process of associating the drop-off locations with the at least one grid of the map. For example, the “mapping” may refer to marking the drop-off locations on the at least one grid of a digital map displayed on the user terminal. As another example, the “mapping” may refer to associating the code of the at least one grid with the code of the drop-off locations (e.g., adding a tag or label of a particular grid to the code of a particular drop-off location).

In 740, the processing device 112 (e.g., classification module 630) may classify the at least one grid into the one or more clusters. In some embodiments, the clusters may be marked on the digital map as boundary lines. For example, if two grids are classified into a same cluster, a boundary line may be drawn along the boundaries of the two grids as the cluster. If a third grid is further classified into the cluster, the boundary line of the cluster may be broadened to include the third grid.

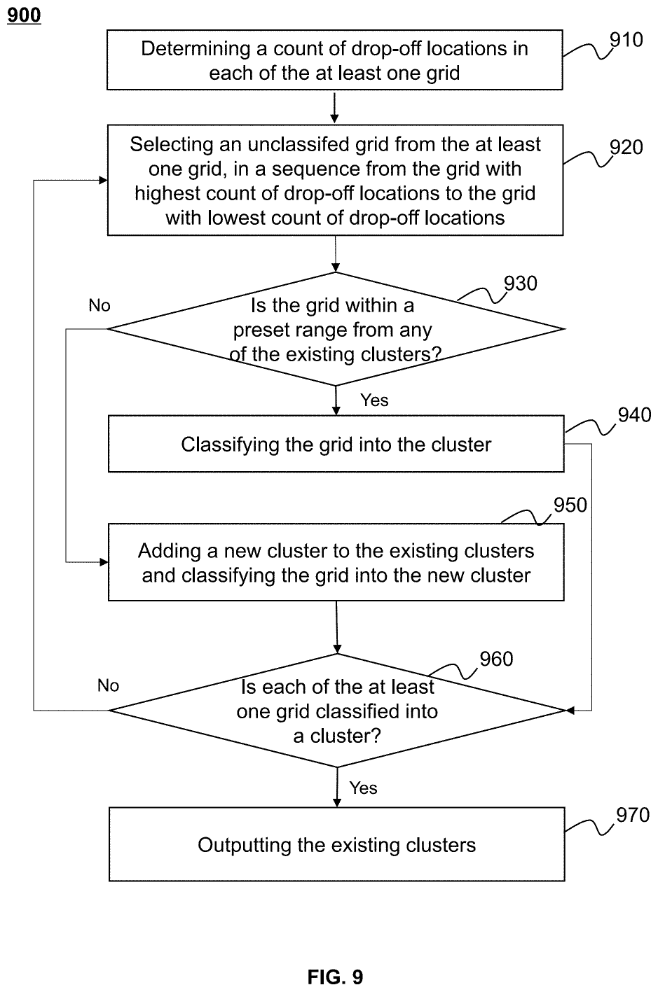

In some embodiments, the processing device 112 may determine a popularity of each of the at least one grid based on the count of the actual drop-off locations in each grid. The processing device 112 may generate a sequence of grid according to the popularity (e.g., from the grid with the highest popularity to the grid with the lowest popularity, or vice versa). The processing device 112 may perform, for each of the at least one grid based on the sequence of the grid, a determination that whether the grid is within a preset range from an existing cluster (e.g., whether the grid is either in the boundary of the cluster or less than a preset range from the boundary of the cluster). In certain embodiments, the term “range” may refer to direct distance; In certain embodiments, the term “range” may refer to navigation distance (e.g. the distance along navigatable routes). In response to a determination that the grid is within a preset range from one of the one or more clusters, the processing device 112 may classify the grid to the cluster. For example, the preset range may be 10 meters, 20 meters, 50 meters, 100 meters, 1 km, 2 km, etc. In response to a determination that the grid is not within a preset range from any of the one or more clusters, the processing device 112 may add a new cluster to the one or more clusters and classify the grid into the new cluster. More descriptions regarding the classification of the at least one grid into the one or more clusters may be found elsewhere in the present disclosure, e.g., FIG. 9 and the descriptions thereof.

In 750, the processing device 112 (e.g., the calculation module 660) may determine a confidence level for each of the one or more clusters. In some embodiments, the confidence level may be determined based on the count of drop-off locations in the cluster and the count of corresponding original destinations in the cluster. Merely by way of example, the confidence level may be determined according to a ratio of the count of the drop-off locations in the cluster and the count of corresponding original destinations in the cluster.

In some embodiments, a cluster with a high ratio (representing high confidence level) may indicate that the cluster includes many drop-off locations but does not include many original destinations. Locations in such cluster are suitable locations for navigation but are usually ignored by a conventional method. A cluster with a low ratio (representing low confidence level) may indicate that the cluster includes many original destinations but does not include many drop-off locations. Locations in such cluster is usually treated as a correct destination by a conventional method. However, this cluster is not suitable because not many service requesters want to be dropped off there. The present method may ignore this cluster.

In 760, the processing device 112 (e.g., the processing module 650) may select at least one target cluster from the one or more clusters according to the confidence level of the one or more clusters. For example, the processing device 112 may determine a ranking of the one or more clusters according to the confidence level of the one or more clusters (e.g., from the cluster with the highest confidence level to the cluster with the lowest confidence level, or vice versa), putting the clusters into a sequence. The processing device 112 may determine a preset number of target clusters. The number of target clusters may be inputted by the user via a user terminal (e.g., the requester terminal 130, the provider terminal 140, a vehicle-mounted terminal on the vehicle 150) or determined by the processing device 112. The preset number of target clusters may be any value, including but not limited to, 1, 2, 5, 10, 20, 50, etc. The processing device 112 may select the number of clusters from the at least one cluster as the one or more target clusters according to the sequence of the cluster. For example, the total count of the one or more clusters may be 100. The processing device 112 may determine the preset number of target clusters as 20. The processing device 112 may select 20 clusters with higher confidence level from the 100 clusters as the target clusters.

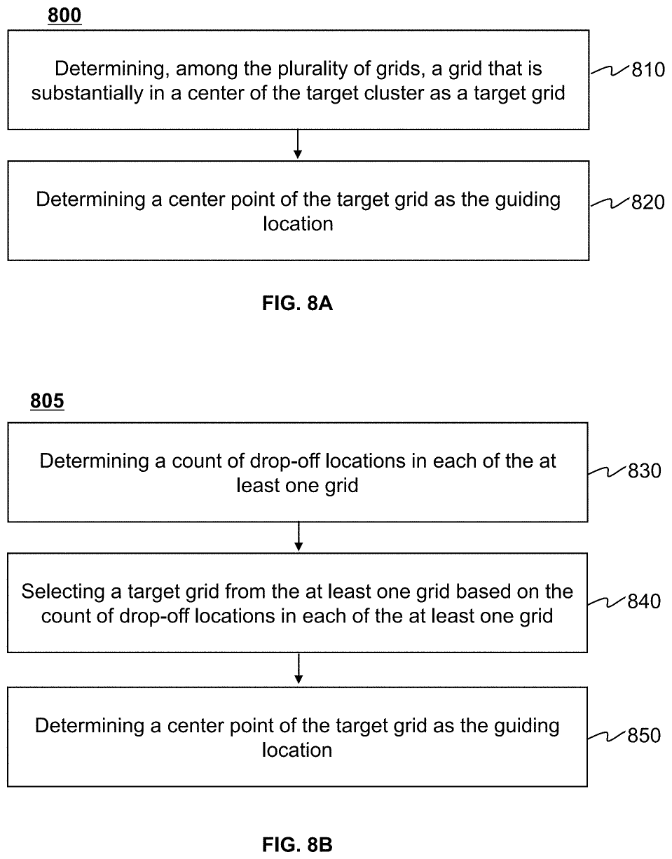

In 770, the processing device 112 (e.g., the processing module 650) may determine a location in the at least one target cluster as a guiding location. In some embodiments, the guiding location may be a center point of a grid in the target cluster. For example, the center point of a center grid in the target cluster may be determined as the guiding location. As another example, the center point of a grid with the highest popularity (e.g., the highest number of drop-off locations) may be determined as the guiding location. As a further example, a point on a boundary between one or more grids or a point at a corner of a grid may be determined as the guiding location. The guiding location may or may not be an actual drop-off location. More descriptions regarding the determinations of the guiding location may be found elsewhere in the present disclosure, e.g., FIG. 8A, FIG. 8B, and the descriptions thereof.

In 780, the processing device 112 (e.g., the determination module 640) may determine whether the guiding location satisfies a preset condition. In some embodiments, the preset condition may be used as a determination for whether the guiding location is a suitable destination of navigation. For example, the preset condition may include the confidence level of a guiding road bound to or associated with the guiding location being greater than or equal to a road threshold. In some embodiments, the processing device 112 may first determine at least one first drop-off location that is already classified into the target cluster. For each of the at least one first drop-off location, the processing device 112 may determine a road associated with the first drop-off location. The processing device 112 may determine a total count of roads associated with the at least one first drop-off location and a count of roads associated with the at least one first drop-off location that are the guiding road. The processing device 112 may determine the confidence level of the guiding road binding to or associated with the guiding location based on the total count of first drop-off locations in the target cluster and the count of roads associated with the at least one first drop-off location that are the guiding road. As another example, the preset condition may include the guiding location being well-known (e.g., easy to be recognized by service provider and/or the navigation system). In response to a determination that the guiding location satisfies the preset condition, the process 700 may proceed to 790; otherwise, the process 700 may proceed back to 770. When the process 700 proceeds back to 770, the processing device 112 may designate another location as the guiding location and proceed to 780. In some embodiments, the center point of a center grid in the target cluster may be determined as the guiding location in a first iteration. If this guiding location doesn't satisfy the preset condition in 780, the processing device 112 may select the center point of a grid with the highest popularity (e.g., the highest number of drop-off locations) in the cluster as the guiding location in a second iteration. If the guiding location in the second iteration doesn't satisfy the preset condition in 780, the processing device 112 may select the center point of a grid with the second highest popularity in the cluster as the guiding location, and so on, until a guiding location that satisfies the preset condition is found.

In 790, the processing device 112 (e.g., the processing module 650) may designate the guiding location as a recommended destination of navigation. When a service requester sends a service request to a service providing platform with a destination that is close to or in the same region as the recommended destination of navigation, the service providing platform may replace the original destination by the recommended destination of navigation. The replacement of the original destination may or may not require a permission of the service requester. For example, the service providing platform, or the associated navigation application may send a message to the service requester to ask him or her whether the original destination is required to be changed to the recommended destination of navigation. More particularly, the service providing platform or the associated navigation application may display two buttons (or virtual buttons) on the user device of the service requester. The two buttons may include a button “confirm to change the destination” and a button “decline to change the destination”. Merely by way of example, the service providing platform or the associated navigation application may display a route from the current location of the service requester to the original destination and a route from the current location of the service requester to the recommended destination of navigation simultaneously to help the service requester decide whether to change the destination. In some embodiments, the service providing platform or the associated navigation application may display a count of historical service requesters that select the original destination as drop-off locations and a count of historical service requesters that select the recommended destination of navigation as drop-off locations. In some embodiments, the “close to” may refer to that the destination is within a preset range from the recommended destination of navigation. For example, the preset range may be any value, including but not limited to 50 meters, 100 meters, 200 meters, etc.

FIG. 8A and FIG. 8B are flowcharts illustrating exemplary processes for determining a guiding location according to some embodiments of the present disclosure. In some embodiments, one or more operations of process 800 and/or process 805 may be executed by the service system 100. For example, the process 800 and/or process 805 may be implemented as a set of instructions (e.g., an application) stored in a storage device (e.g., the storage device 160, the ROM 230, the RAM 240, the storage 390) and invoked and/or executed by a processing device (e.g., the processing device 112, the processor 220 of the computing device 200, the CPU 340 of the mobile device 300, and/or the modules illustrated in FIG. 6). In some embodiments, the instructions may be transmitted in the form of electronic current or electrical signals. The operations of the illustrated process present below are intended to be illustrative. In some embodiments, the process 800 and/or the process 805 may be accomplished with one or more additional operations not described and/or without one or more of the operations herein discussed. Additionally, the order in which the operations of the process as illustrated in FIG. 8A and FIG. 8B and described below is not intended to be limiting.

The process 800 and the process 805 may be two exemplary methods for determining the guiding location, however, they shall not be limiting. Other methods for determining the guiding location may be used and are also within the scope of the present disclosure. The process 800 and the process 805 may correspond to operation 770 in FIG. 7.

In 810, the processing device 112 (e.g., the processing module 650) may determine, among the plurality of grids, a grid that is substantially in a center of the target cluster as a target grid. For example, the target cluster may be an irregular shape with straight boundaries that includes a plurality of grids. The processing device 112 may determine a geometrical center point (or gravity point) of the target cluster. The target grid may be a grid that includes the geometrical center point of the target cluster.

In 820, the processing device 112 (e.g., the processing module 650) may determine a center point of the target grid as the guiding location. For example, if the coordinates of the target grid are (20-40, 30-60), the coordinate of the center point of the target grid (i.e., the guiding location) may be (30, 45).

In 830, the processing device 112 (e.g., the processing module 650) may determine a count of drop-off locations in each of the at least one grid.

In 840, the processing device 112 (e.g., the processing module 650) may select a target grid from the at least one grid based on the count of drop-off locations in each of the at least one grid. For example, the target grid may have the highest count of drop-off locations among the at least one grid in the target cluster.

In 850, the processing device 112 (e.g., the processing module 650) may determine a center point of the target grid as the guiding location.

FIG. 9 is a flowchart illustrating an exemplary process for classifying grid into clusters according to some embodiments of the present disclosure. In some embodiments, one or more operations of process 900 may be executed by the service system 100. For example, the process 900 may be implemented as a set of instructions (e.g., an application) stored in a storage device (e.g., the storage device 160, the ROM 230, the RAM 240, the storage 390) and invoked and/or executed by a processing device (e.g., the processing device 112, the processor 220 of the computing device 200, the CPU 340 of the mobile device 300, and/or the modules illustrated in FIG. 6). In some embodiments, the instructions may be transmitted in the form of electronic current or electrical signals. The operations of the illustrated process present below are intended to be illustrative. In some embodiments, the process 900 may be accomplished with one or more additional operations not described and/or without one or more of the operations herein discussed. Additionally, the order in which the operations of the process as illustrated in FIG. 9 and described below is not intended to be limiting.

The process 900 may correspond to operation 740 in FIG. 7.

In 910, the processing device 112 (e.g., the processing module 650) may determine a count of drop-off locations in each of the at least one grid.

In 920, the processing device 112 (e.g., the processing module 650) may obtain an unclassified grid from the at least one grid. The processing device 112 may obtain the unclassified grid in a sequence from the grid with highest count of drop-off locations to the grid with lowest count of drop-off locations. For example, in the first iteration, the grid with the highest count of drop-off locations may be selected.

In 930, the processing device 112 (e.g., the determination module 640) may determine whether the selected grid is within a preset range from any of the existing cluster. In some embodiments, the “within a preset range” may refer to that the grid is either within the boundary of the cluster or less than a preset range from the boundary of the cluster. The preset range may be any value, including but not limited to 10 meters, 20 meters, 30 meters, 50 meters, 100 meters. In response to a determination that the grid is within a preset range from any of the existing cluster, the process 900 may proceed to 940; otherwise, the process 900 may proceed to 950.

In 940, the processing device 112 (e.g., the classification module 630) may classify the grid into the cluster that the grid is within the preset range from. In some embodiments, the boundary of the cluster may be broadened to include the grid. If a grid is within a preset range from two or more clusters, the grid may be classified into a cluster that it is closer to.

In 950, the processing device 112 (e.g., the classification module 630) may add a new cluster to the existing clusters and classify the grid into the new cluster.

In some embodiments, regardless of whether the grid is within a preset range from any of the existing clusters, the process 900 may proceed to 960. In other words, regardless of either operation 940 or operation 950 is performed. The process 900 may proceed to 960.

In 960, the processing device 112 (e.g., the determination module 640) may determine whether the at least one grid is all traversed, in other words, whether each of the at least one grid is classified into a cluster (either a new cluster or an existing cluster). In response to a determination that each of the at least one grid is classified into a cluster, the process 900 may proceed to 970; otherwise, the process 900 may proceed back to 920. For example, in the first iteration, the processing device 112 may create a new cluster and classify the grid with highest count of drop-off locations into the new cluster. In the second iteration, the processing device 112 may determine whether the grid with the second highest count of drop-off locations is within a preset range from the existing cluster (e.g., the new cluster created in the first iteration). If the grid with the second highest count of drop-off locations is within a preset range from the existing cluster, the grid with the second highest count of drop-off locations may be classified into the cluster created in the first iteration; otherwise, a new cluster may be created for the grid with the second highest count of drop-off locations. The similar operations may be performed for other grids until all of the at least one grid is classified into a cluster (either a new cluster or an existing cluster).

In 970, the processing device 112 may output the existing clusters as the classification result of the grids.

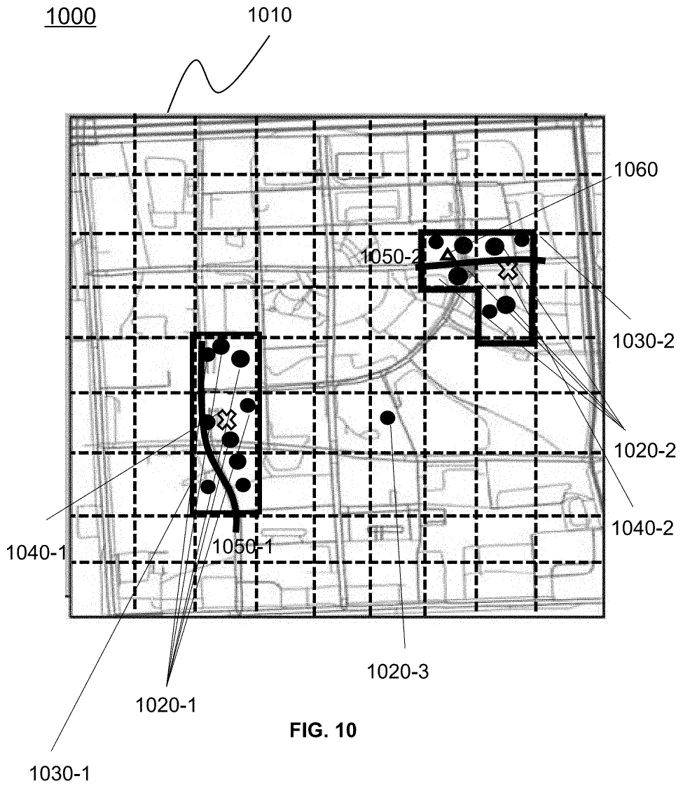

FIG. 10 is schematic diagram illustrating the determination of a destination of navigation according to some embodiments of the present disclosure.

As shown in FIG. 10, a map 1000 may include a plurality of roads, buildings and regions. A plurality of grids 1010 may be formed on the map. The processing device 112 may first obtain a plurality of historical orders and extract a plurality of drop-off locations from the plurality of historical orders. The processing device 112 may map the plurality of drop-off locations (e.g., drop-off locations 1020-1, 1020-2, 1020-3 labelled in circles) onto the plurality of grids 1010 of the map 1000. The processing device 112 may then classify the grids 1010 into a plurality of clusters. For example, the three grids on the left may be classified into a first cluster 1030-1. The three grids on the right may be classified into a second cluster 1030-2. Drop-off location 1020-3 and its corresponding grid may not be classified because the count of drop-off location in the grid is too low (e.g., only one). The processing device 112 may then determine a confidence level for the first cluster 1030-1 and the second cluster 1030-2. Assuming these two clusters each has a confidence level greater than a threshold and are both selected as a target cluster. The processing device 112 may determine a guiding location for each of the first cluster 1030-1 and the second cluster 1030-2. For example, a center point 1040-1 (labeled in a cross) of a center grid of the first cluster 1030-1 may be determined as a guiding location of the first cluster 1030-1 and a center point 1040-2 (labelled in a cross) of a center grid of the second cluster 1030-2 may be determined as a guiding location of the second cluster 1030-2. The processing device 112 may determine a confidence level of a road (e.g., the road 1050-1, the road 1050-2) binding to or associated with the guiding locations. If the confidence level of the road 1050-1 is greater than a road threshold, the guiding location 1040-1 may be designated as a recommended destination of navigation. If the confidence level of the road 1050-2 is less than the road threshold, the processing device may select another location (e.g., the location 1060 labelled in a triangle which is the center point of a grid with the highest count of drop-off locations in the second cluster 1030-2) as the guiding location, and so on, until a road associated with or binding to a guiding location in the second cluster 1030-2 has a confidence level greater than or equal to the road threshold.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment

### STATEMENT OF INVENTION

1. A system, comprising:

at least one computer-readable storage medium including a set of instructions for determining a recommended destination of navigation; and

at least one processor in communication with the at least one computer-readable storage medium, wherein when executing the set of instructions, the at least one processor is directed to:

obtain a plurality of historical service orders, each having a drop-off location and an original destination;

classify the drop-off locations into one or more clusters;

select at least one target cluster from the one or more clusters according to a confidence level of each cluster, wherein the confidence level is determined based on the drop-off locations in the cluster and the corresponding original destinations; and

for each of the at least one target cluster,
determine a location in the target cluster as a guiding location; and
designate the guiding location as the recommended destination of navigation.
   2. The system of item 1, wherein to classify the drop-off locations into one or more clusters, the at least one processor is directed to:

map the plurality of drop-off locations onto at least one grid of a map; and

classify the at least one grid into the one or more clusters.

3. The system of item 2, wherein to classify the at least one grid into the one or more clusters, the at least one processor is directed to:

determine a count of drop-off locations in each of the at least one grid;

determine, in a sequence related to the count of drop-off locations in each of the at least one grid, whether a grid is within a preset range from any of the one or more clusters; and

in response to a determination that the grid is within a preset range from one of the one or more clusters, classify the grid to the cluster; or

in response to a determination that the grid is not within a preset range from any of the one or more clusters, add a new cluster to the one or more clusters and classify the grid to the new cluster.

4. The system of any one of items 1-3, wherein to select the one or more target clusters from the at least one cluster according to the confidence level of the at least one cluster, the at least one processor is directed to:

determine a sequence of the at least one cluster according to the confidence level;

determine a number of target clusters; and

select the number of clusters from the at least one cluster as the one or more target clusters according to the sequence.

5. The system of any one of items 1-4, wherein when executing the set of instructions, the at least one processor is further directed to:

determine a guiding road associated with the guiding location;

determine a confidence level of the guiding road;

determine whether the confidence level of the guiding road is greater than a road confidence level threshold; and
in response to a determination that the confidence level of the guiding road is greater than or equal to the road confidence level threshold, designate the guiding location as the recommended destination of navigation; or
in response to a determination that the confidence level of the guiding road is less than the road confidence level threshold, determine another location in the target cluster as the guiding location.
   6. The system of item 5, wherein to determine the confidence level of the guiding road associated with the guiding location, the at least one processor is directed to:

determine at least one first drop-off location that is classified into the target cluster;

for each of the at least one first drop-off location, determine a road associated with the first drop-off location;

determine a total count of roads associated with the at least one first drop-off location;

determine a count of roads associated with the at least one first drop-off location that are the guiding road; and

determine the confidence level of the road associated with the guiding location based on the count of roads associated with the at least one first drop-off location that are the guiding road and the total count of roads associated with the at least one first drop-off location in the target cluster.

7. The system of any one of items 1-6, wherein to determine a location in the target cluster as the guiding location, the at least one processor is directed to:

map the target cluster onto at least one grid of a map;

determine, among the plurality of grids, a grid that is substantially in a center of the target cluster as a target grid; and

determine a center point of the target grid as the guiding location.

8. The system of any one of items 1-7, wherein to determine a location in the target cluster as the guiding location, the at least one processor is directed to:

map the target cluster onto at least one grid of a map;

determine a count of drop-off locations in each of the at least one grid;

select a target grid from the at least one grid based on the count of drop-off locations in each of the at least one grid; and

determine a center point of the target grid as the guiding location.

9. The system of any one of items 1-8, wherein the confidence level is a ratio of a count of the drop-off locations in the cluster and a count of corresponding original destinations in the cluster.
10. The system of any one of items 1-9, wherein the at least one processor is further directed to:

receive a service request from a service requester, the service request including a requested destination that is related to a recommended destination of navigation; and

replace the requested destination in the service request by the recommended destination of navigation.

11. A method implemented on a computing device having at least one processor, at least one storage medium, and a communication platform connected to a network, the method comprising:

obtaining a plurality of historical service orders, each having a drop-off location and an original destination;

classifying the drop-off locations into one or more clusters;

selecting at least one target cluster from the one or more clusters according to a confidence level of each cluster, wherein the confidence level is determined based on the drop-off locations in the cluster and the corresponding original destinations; and

for each of the at least one target cluster,
determining a location in the target cluster as a guiding location; and
designating the guiding location as the recommended destination of navigation.
   12. The method of item 11, wherein the classifying the drop-off locations into one or more clusters includes:

mapping the plurality of drop-off locations onto at least one grid of a map; and

classifying the at least one grid into the one or more clusters.

13. The method of item 12, wherein the classifying the at least one grid into the one or more clusters includes:

determining a count of drop-off locations in each of the at least one grid;

determining, in a sequence related to the count of drop-off locations in each of the at least one grid, whether a grid is within a preset range from any of the one or more clusters; and

in response to a determination that the grid is within a preset range from one of the one or more clusters, classifying the grid to the cluster; or

in response to a determination that the grid is not within a preset range from any of the one or more clusters, adding a new cluster to the one or more clusters and classify the grid to the new cluster.

14. The method of any one of items 11-13, wherein the selecting the one or more target clusters from the at least one cluster according to the confidence level of the at least one cluster includes:

determining a sequence of the at least one cluster according to the confidence level;

determining a number of target clusters; and

selecting the number of clusters from the at least one cluster as the one or more target clusters according to the sequence.

15. The method of any one of items 11-14, further comprising:

determining a guiding road associated with the guiding location;

determining a confidence level of the guiding road;

determining whether the confidence level of the guiding road is greater than a road confidence level threshold; and
in response to a determination that the confidence level of the guiding road is greater than or equal to the road confidence level threshold, designating the guiding location as the recommended destination of navigation; or
in response to a determination that the confidence level of the guiding road is less than the road confidence level threshold, determining another location in the target cluster as the guiding location.
   16. The method of item 15, wherein the determining the confidence level of the guiding road associated with the guiding location includes:

determining at least one first drop-off location that is classified into the target cluster;

for each of the at least one first drop-off location, determining a road associated with the first drop-off location;

determining a total count of roads associated with the at least one first drop-off location;

determining a count of roads associated with the at least one first drop-off location that are the guiding road; and

determining the confidence level of the road associated with the guiding location based on the count of roads associated with the at least one first drop-off location that are the guiding road and the total count of roads associated with the at least one first drop-off location in the target cluster.

17. The method of any one of items 11-16, wherein the determining a location in the target cluster as the guiding location includes:

mapping the target cluster onto at least one grid of a map;

determining, among the plurality of grids, a grid that is substantially in a center of the target cluster as a target grid; and

determining a center point of the target grid as the guiding location.

18. The method of any one of items 11-17, wherein the determining a location in the target cluster as the guiding location includes:

mapping the target cluster onto at least one grid of a map;

determining a count of drop-off locations in each of the at least one grid;

selecting a target grid from the at least one grid based on the count of drop-off locations in each of the at least one grid; and

determining a center point of the target grid as the guiding location.

19. The method of any one of items 11-18, wherein the confidence level is a ratio of a count of the drop-off locations in the cluster and a count of corresponding original destinations in the cluster.
20. The method of any one of items 11-19, further comprising:

receiving a service request from a service requester, the service request including a requested destination that is related to a recommended destination of navigation; and

replacing the requested destination in the service request by the recommended destination of navigation.

21. A non-transitory computer readable medium, comprising executable instructions that, when executed by at least one processor, directs the at least one processor to perform a method, the method comprising:

obtaining a plurality of historical service orders, each having a drop-off location and an original destination;

classifying the drop-off locations into one or more clusters;

selecting at least one target cluster from the one or more clusters according to a confidence level of each cluster, wherein the confidence level is determined based on the drop-off locations in the cluster and the corresponding original destinations; and

for each of the at least one target cluster,
determining a location in the target cluster as a guiding location; and
designating the guiding location as the recommended destination of navigation.

1-15. (canceled)

16. A system, comprising:
at least one computer-readable storage medium including a set of instructions for determining a recommended destination of navigation; and
at least one processor in communication with the at least one computer-readable storage medium, wherein when executing the set of instructions, the at least one processor is directed to:
obtain a plurality of historical service orders, each having a drop-off location and an original destination;
classify the drop-off locations into one or more clusters;
select at least one target cluster from the one or more clusters according to a confidence level of each cluster, wherein the confidence level is determined based on the drop-off locations in the cluster and the corresponding original destinations; and
for each of the at least one target cluster,
determine a location in the target cluster as a guiding location; and
designate the guiding location as the recommended destination of navigation.

17. The system of claim 16, wherein to classify the drop-off locations into one or more clusters, the at least one processor is directed to:
map the drop-off locations onto at least one grid of a map; and
classify the at least one grid into the one or more clusters.

18. The system of claim 17, wherein to classify the at least one grid into the one or more clusters, the at least one processor is directed to:
determine a count of drop-off locations in each of the at least one grid;
determine, in a sequence related to the count of drop-off locations in each of the at least one grid, whether a grid is within a preset range from any of the one or more clusters; and
in response to a determination that the grid is within the preset range from one of the one or more clusters, classify the grid to the cluster; or
in response to a determination that the grid is not within the preset range from any of the one or more clusters, add a new cluster to the one or more clusters and classify the grid to the new cluster.

19. The system of claim 16, wherein to select the at least one target cluster from the one or more clusters according to the confidence level of each cluster, the at least one processor is directed to:
determine a sequence of the one or more clusters according to the confidence level;
determine a number of target clusters; and
select the number of clusters from the one or more clusters as the target clusters according to the sequence.

20. The system of claim 16, wherein when executing the set of instructions, the at least one processor is further directed to:
determine a guiding road associated with the guiding location;
determine a confidence level of the guiding road;
determine whether the confidence level of the guiding road is greater than a road confidence level threshold; and
in response to a determination that the confidence level of the guiding road is greater than or equal to the road confidence level threshold, designate the guiding location as the recommended destination of navigation; or
in response to a determination that the confidence level of the guiding road is less than the road confidence level threshold, determine another location in the target cluster as the guiding location.

21. The system of claim 20, wherein to determine the confidence level of the guiding road associated with the guiding location, the at least one processor is directed to:
determine at least one first drop-off location that is classified into the target cluster;
for each of the at least one first drop-off location, determine a road associated with the first drop-off location;
determine a total count of roads associated with the at least one first drop-off location;
determine a count of roads associated with the at least one first drop-off location that are guiding road; and
determine the confidence level of the road associated with the guiding location based on the count of roads associated with the at least one first drop-off location that are the guiding road and the total count of roads associated with the at least one first drop-off location in the target cluster.

22. The system of claim 16, wherein to determine a location in the target cluster as the guiding location, the at least one processor is directed to:
map the target cluster onto one or more grids of a map;
determine, among the one or more grids, a grid that is substantially in a center of the target cluster as a target grid; and
determine a center point of the target grid as the guiding location.

23. The system of claim 16, wherein to determine a location in the target cluster as the guiding location, the at least one processor is directed to:
map the target cluster onto at least one grid of a map;
determine a count of drop-off locations in each of the at least one grid;
select a target grid from the at least one grid based on the count of drop-off locations in each of the at least one grid; and
determine a center point of the target grid as the guiding location.

24. The system of claim 16, wherein the confidence level is a ratio of a count of the drop-off locations in the cluster and a count of corresponding original destinations in the cluster.

25. The system of claim 16, wherein the at least one processor is further directed to:
receive a service request from a service requester, the service request including a requested destination that is related to a recommended destination of navigation; and
replace the requested destination in the service request by the recommended destination of navigation.

26. A method implemented on a computing device having at least one processor, at least one storage medium, and a communication platform connected to a network, the method comprising:
obtaining a plurality of historical service orders, each having a drop-off location and an original destination;
classifying the drop-off locations into one or more clusters;
selecting at least one target cluster from the one or more clusters according to a confidence level of each cluster, wherein the confidence level is determined based on the drop-off locations in the cluster and the corresponding original destinations; and
for each of the at least one target cluster,
determining a location in the target cluster as a guiding location; and
designating the guiding location as the recommended destination of navigation.

27. The method of claim 26, wherein the classifying the drop-off locations into one or more clusters includes:
mapping the drop-off locations onto at least one grid of a map; and
classifying the at least one grid into the one or more clusters.

28. The method of claim 27, wherein the classifying the at least one grid into the one or more clusters includes:
determining a count of drop-off locations in each of the at least one grid;
determining, in a sequence related to the count of drop-off locations in each of the at least one grid, whether a grid is within a preset range from any of the one or more clusters; and
in response to a determination that the grid is within the preset range from one of the one or more clusters, classifying the grid to the cluster; or
in response to a determination that the grid is not within the preset range from any of the one or more clusters, adding a new cluster to the one or more clusters and classifying the grid to the new cluster.

29. The method of claim 26, wherein the selecting the at least one target cluster from the one or more clusters according to the confidence level of each cluster includes:
determining a sequence of the one or more clusters according to the confidence level;
determining a number of target clusters; and
selecting the number of clusters from the one or more clusters as the target clusters according to the sequence.

30. The method of claim 26, further comprising:
determining a guiding road associated with the guiding location;
determining a confidence level of the guiding road;
determining whether the confidence level of the guiding road is greater than a road confidence level threshold; and
in response to a determination that the confidence level of the guiding road is greater than or equal to the road confidence level threshold, designating the guiding location as the recommended destination of navigation; or
in response to a determination that the confidence level of the guiding road is less than the road confidence level threshold, determining another location in the target cluster as the guiding location.

31. The method of claim 30, wherein the determining the confidence level of the guiding road associated with the guiding location includes:
determining at least one first drop-off location that is classified into the target cluster;
for each of the at least one first drop-off location, determining a road associated with the first drop-off location;
determining a total count of roads associated with the at least one first drop-off location;
determining a count of roads associated with the at least one first drop-off location that are the guiding road; and
determining the confidence level of the road associated with the guiding location based on the count of roads associated with the at least one first drop-off location that are the guiding road and the total count of roads associated with the at least one first drop-off location in the target cluster.

32. The method of claim 26, wherein the determining a location in the target cluster as the guiding location includes:
mapping the target cluster onto one or more grids of a map;
determining, among the one or more grids, a grid that is substantially in a center of the target cluster as a target grid; and
determining a center point of the target grid as the guiding location.

33. The method of claim 26, wherein the determining a location in the target cluster as the guiding location includes:
mapping the target cluster onto at least one grid of a map;
determining a count of drop-off locations in each of the at least one grid;
selecting a target grid from the at least one grid based on the count of drop-off locations in each of the at least one grid; and
determining a center point of the target grid as the guiding location.

34. The method of claim 26, further comprising:
receiving a service request from a service requester, the service request including a requested destination that is related to a recommended destination of navigation; and
replacing the requested destination in the service request by the recommended destination of navigation.

35. A non-transitory computer readable medium, comprising executable instructions that, when executed by at least one processor, directs the at least one processor to perform a method, the method comprising:
obtaining a plurality of historical service orders, each having a drop-off location and an original destination;
classifying the drop-off locations into one or more clusters;
selecting at least one target cluster from the one or more clusters according to a confidence level of each cluster, wherein the confidence level is determined based on the drop-off locations in the cluster and the corresponding original destinations; and
for each of the at least one target cluster,
determining a location in the target cluster as a guiding location; and
designating the guiding location as the recommended destination of navigation.
